(19) United States
(12) Patent Application Publication
(10) Pub. No.: US 2022/0100847 A1
(43) Pub. Date: Mar. 31, 2022

(54) Neural Network Robustness through Obfuscation

(71) Applicant: International Business Machines Corporation, Armonk, NY (US)

(72) Inventors: Mark Wegman, Mt. Kisco, NY (US); Haifeng Qian, Mt. Kisco, NY (US); Ian Michael Molloy, Chappaqua, NY (US); Taesung Lee, Ridgefield, CT (US); Chiayi Hsu, Taipei City (TW)

(73) Assignee: International Business Machines Corporation, Armonk, NY (US)

(21) Appl. No.: 17/036,046

(22) Filed: Sep. 29, 2020

(51) Int. Cl. G06F 21/55; G06N 3/08; G06N 3/04

(52) U.S. Cl. CPC G06F 21/55; G06F 2221/034; G06N 3/0454; G06N 3/08

(57) ABSTRACT

A computer system, computer program product, and computer implemented method to enhance robustness an artificial neural network through obfuscation. One or more high frequency and low amplitude elements are added to the artificial neural network. The added elements provide a defense mechanism to the artificial network, thereby functioning as a security mechanism against an adversarial attack.

### BACKGROUND

The present embodiments relate to an artificial intelligence platform and an optimization methodology directed at training data and a corresponding artificial neural network. It is understood that an adversary can introduce or try to introduce an adversarial attack on an artificial neural network (ANN) through introduction of inappropriate or improper samples into a training set. This introduction, if permitted, may result in the ANN misclassification of received input. Accordingly, embodiments are provided to construct and train the corresponding neural network with data that reduces or eliminates an adversarial attack on the network.

### SUMMARY

The embodiments include a computer system, computer program product, and computer implemented method for enhancing security of an artificial neural network, and in particular embodiment, improvements are directed to obfuscating an attack on the artificial neural network.

In one aspect, a system is provided for use with a computer system including a processing unit, e.g. processor, operatively coupled to memory. The processing unit is configured to implement a program model to introduce a function having as input results from one or more previous layers of a first artificial neural network (ANN). The introduced function has at least one local minima, and in an exemplary embodiment is a trigonometric function. Responsive to the first ANN receiving input data, the first ANN applies the introduced function to the received input data, and generates output data classifying interpreted received input. In an embodiment, the system includes at least one program model to construct a decoy to an adversarial attack, with the decoy being a second ANN constructed as a replica of the first ANN. The weights of the first ANN are shared with the second ANN, but the second ANN does not include the introduced function of the first ANN. This embodiment includes performance of a training process with a training data set to modify the shared weights of the first and second ANN, with the training process creating both a trained first ANN and a trained second ANN. Once trained, the first ANN commonly produces a correct answer on the training set, while the second ANN commonly produces an incorrect answer on the training set.

In another aspect, a computer program product is provided to direct performance and security of an artificial neural network. The computer program product includes a computer readable storage medium having program code embodied therewith, with the program code executable by a processor. Program code is provided to introduce a function having as input results from one or more previous layers of a first artificial neural network (ANN). The introduced function has at least one local minima, and in an exemplary embodiment is a trigonometric function. Responsive to the first ANN receiving input data, the first ANN applies the introduced function to the received input data, and generates output data classifying interpreted received input. In an embodiment, the computer program product includes program code to construct a decoy to an adversarial attack, with the decoy being a second ANN constructed as a replica of the first ANN. The weights of the first ANN are shared with the second ANN, but the second ANN does not include the introduced function of the first ANN. This embodiment includes performance of a training process with a training data set to modify the shared weights of the first and second ANN, with the training process creating both a trained first ANN and a trained second ANN. Once trained, the first ANN commonly produces a correct answer on the training set, while the second ANN commonly produces an incorrect answer on the training set.

In yet another aspect, a method is provided for directing performance and security of an artificial neural network. The method encompasses introducing a function having as input results from one or more previous layers of a first artificial neural network (ANN). The introduced function has at least one local minima, and in an exemplary embodiment is a trigonometric function. Responsive to the first ANN receiving input data, the first ANN applies the introduced function to the received input data, and generates output data classifying interpreted received input. In an embodiment, a decoy to an adversarial attack is constructed, with the decoy being a second ANN constructed as a replica of the first ANN. The weights of the first ANN are shared with the second ANN, but the second ANN does not include the introduced function of the first ANN. This embodiment includes performing a training process with a training data set to modify the shared weights of the first and second ANN, with the training process creating both a trained first ANN and a trained second ANN. Once trained, the first ANN commonly produces a correct answer on the training set, while the second ANN commonly produces an incorrect answer on the training set.

These and other aspects, including but not limited to systems, apparatus, products, assemblies, sub-assemblies, methods, and processes will become apparent from the following detailed description of the exemplary embodiment(s), taken in conjunction with the accompanying drawings.

### BRIEF DESCRIPTION OF THE SEVERAL VIEWS OF THE DRAWINGS

The drawings referenced herein form a part of the specification and are incorporated herein by reference. Features shown in the drawings are meant as illustrative of only some embodiments, and not of all embodiments, unless otherwise explicitly indicated.

FIG. 1 depicts a block diagram illustrating an example atomic structure within the neural model.

FIG. 2 depicts a block diagram to illustrate an example schematic of a neural network.

FIG. 3 depicts a system diagram of an artificial intelligence (AI) platform computing system in a network environment.

FIG. 4 depicts a block diagram illustrating the artificial intelligence platform tools, as shown and described in FIG. 3, and their associated application program interfaces.

FIG. 5 depicts a flow chart illustrating a process for training an artificial neural network (ANN) with validation of data points of a corresponding training set.

FIG. 6A depicts a flow chart illustrating a process for creating a decoy ANN.

FIG. 6B depicts a block diagram illustrating an example visualizing what the first ANN does in the image recognition process.

FIG. 6C depicts a block diagram illustrating an example visualizing what the first ANN does in the image recognition process.

FIG. 7 depicts a chart illustrating an example of testing and evaluation of the ANN with the modified activation function.

FIG. 8 depicts a chart illustrating an example of testing and evaluation of the ANN with the modified activation function.

FIG. 9 depicts a block diagram illustrating an example of a computer system/server of a cloud based support system, to implement the system and processes described above with respect to FIGS. 1-8.

FIG. 10 depicts a block diagram illustrating a cloud computer environment.

FIG. 11 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” “an exemplary embodiment,” or “an embodiment” means that a particular feature, structure, or characteristic described in connection with the embodiment is included in at least one embodiment. Thus, appearances of the phrases “a select embodiment,” “in one embodiment,” “in an exemplary embodiment,” or “in an embodiment” in various places throughout this specification are not necessarily referring to the same embodiment. The embodiments described herein may be combined with one another and modified to include features of one another. Furthermore, the described features, structures, or characteristics of the various embodiments may be combined and modified in any suitable manner.

In the following description, numerous specific details are provided to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Artificial Intelligence (AI) relates to the field of computer science directed at computers and computer behavior as related to humans. AI refers to the intelligence when machines, based on information, are able to make decisions, which maximizes the chance of success in a given topic. More specifically, AI is able to learn from a data set to solve problems and provide relevant recommendations. For example, in the field of artificial intelligent computer systems, natural language systems (such as the IBM Watson® artificially intelligent computer system or other natural language interrogatory answering systems) process natural language based on system acquired knowledge. To process natural language, the system may be trained with data derived from a database or corpus of knowledge, but the resulting outcome can be incorrect or inaccurate for a variety of reasons.

Machine learning (ML), which is a subset of AI, utilizes algorithms to learn from data and create foresights based on this data. More specifically, ML is the application of AI through creation of models, for example, neural networks that can demonstrate learning behavior by performing tasks that are not explicitly programmed. Deep learning is a type of ML in which systems can accomplish complex tasks by using multiple layers of neurons that activate based on an output or outputs of a previous layer of neurons, creating increasingly smarter and more abstract activations.

At the core of AI and associated reasoning lies the concept of similarity. Structures, including static structures and dynamic structures, dictate a determined output or action for a given determinate input. More specifically, the determined output or action is based on an express or inherent relationship within the structure. This arrangement may be satisfactory for select circumstances and conditions. However, it is understood that dynamic structures are inherently subject to change, and the output or action may be subject to change accordingly. Existing solutions for efficiently identifying objects and understanding natural language and processing content response to the identification and understanding as well as changes to the structures are extremely difficult at a practical level.

Deep learning is a method of machine learning that incorporates neurons in successive layers to learn from data in an iterative manner. Neural networks are models of the way the nervous system operates. Basic units are referred to as neurons, which are typically organized into layers. Within an artificial neural network, the neuron is a placeholder for a mathematical function. The neuron receives input, applies the mathematical function on the input, thereby generating output. Connections between neurons are characterized by weights, which represent the significance of the connection. The neural network works by simulating a large number of interconnected processing units that resemble abstract versions of neurons. There are typically three parts in a neural network, including an input layer, with units representing input fields, one or more hidden layers, and an output layer, with a unit or units representing target field(s). The units are connected with varying connection strengths or weights. Input data are presented to the first layer, and values are propagated from each neuron to some neurons in the next layer. At a basic level, each layer of the neural network includes one or more operators or functions operatively coupled to output and input. The outputs of evaluating the activation functions of each neuron with provided inputs are referred to herein as activations. Deep learning complex neural networks are designed to emulate how the human brain works, so computers can be trained to support poorly defined abstractions and problems where training data is available. Neural networks and deep learning are often used in image recognition, speech, and computer vision applications.

AI, especially deep learning, has made significant progress in a lot of areas, such as autonomous driving, machine translation, and speech recognition, with profound impact on our society. As used herein, an adversary is at least one entity with an intent to corrupt a neural model through alteration of model behavior by manipulating the data that is used to train the model, i.e., the training data set, thereby effecting a source-target misclassification attack, sometimes referred to as a targeted attack, and hereon referred to as an attack.

Machine learning uses a variety of algorithms that iteratively learn from data to improve, described data, and predict outcomes. A training data set is a set of pairs of input patterns with corresponding desired output patterns. Each pair is represents how the network is supposed to respond to a particular input. A machine learning (ML) model is the output generated when a corresponding machine learning algorithm is trained with the training set. After training is complete and the ML model is provided with input, the ML model generates output.

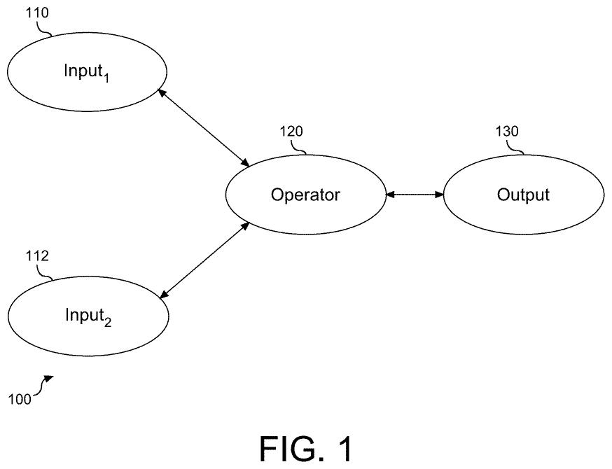

The running of a neural network is a sequence of layer-based computation. The prediction process of neural networks can be treated as a pipeline computation of different layers. The neural network consists of three or more layers, including an input layers, one or more hidden layers, and an output layer. The input layer provides information to the network. No computation is performed at the input layer. Rather, the input layer functions to pass data to the one or more hidden layers. The hidden layer is comprised of one or more nodes, and functions to perform computation(s) on features entered through the input layer, and further functions to transfer results from the computation(s) to the output layer. The output layer functions to produce or communicate information learned by the network. Referring to FIG. 1, a block diagram (100) is provided to illustrate an example atomic structure within the neural model. As shown, an operator (120) is operatively coupled to output (130) and input (110) and (112). In an embodiment, the atomic structure is a representation of an innermost layer of the neural model. Accordingly, the operator (120) and the output (130) are provided, e.g. given, and the input (110) and (112) are ascertained from the operator (120) and the output (130).

A basic building block of the neural network is referred to as a neuron, which takes in input and generates output. As such, the neuron is a placeholder for a mathematical function. The neuron provides the output by applying the function, also referred to herein as an activation function, on the provided input. The activation function is a non-linear function added into the neural network to facilitate learning patterns in the corresponding data. More specifically, the activation function is a non-linear mathematical function between input feeding a current neuron in a current hidden layer, and its output going to the next layer. The purpose of the activation function is to imbed a non-linear property to realize complex mathematical mappings to solve tasks. The activation function decides whether a neuron should be activated or not by calculating a weighted sum and further adding bias. Accordingly, the activation function facilitates the network learning complex patterns in the data.

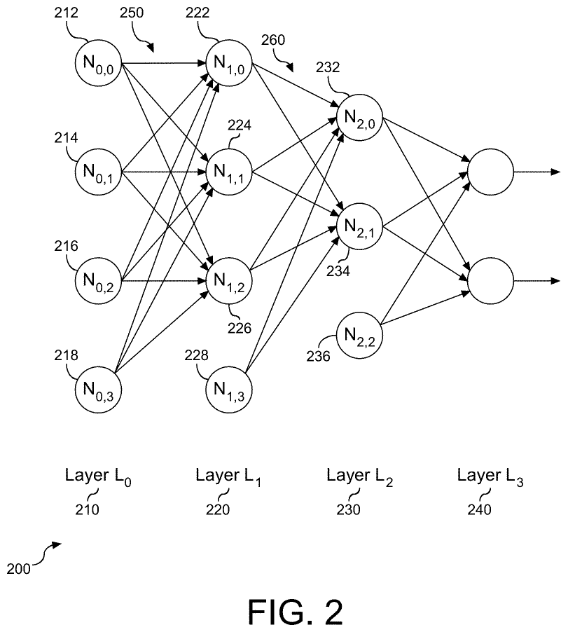

Referring to FIG. 2, a block diagram schematic of an example neural network (200) according to an embodiment is provided. In this example, the neural network (200) includes an input layer (210), a plurality of hidden layers (220) and (230), and an output layer (240). As shown, each layer is represented by neurons. The input layer, L₀, (210) is shown with four neurons, N, including N_{0,0} (212), N_{0,1} (214), N_{0,2} (216), and N_{0,3} (218). The first hidden layer, L₁, (220) is shown with four neurons, including N_{1,0} (222), N_{1,1} (224), N_{1,2} (226), and N_{1,3} (228). Connections (250) are shown between each of the neurons in the input layer, L₀, (210) and the first hidden layer, L₁, (220). The second hidden layer L₂, (230) is shown with three neurons, including N_{2,0} (232), N_{2,1} (234), and N_{2,2} (236), and connections (260) are shown between each of the neurons in the first hidden layer, L₁, (220) and the second hidden layer L₂, (230). The output layer, L₃, (240) contains all the possible outputs from the neural network. Each neuron in the first hidden layer (220) is subject to mathematical processing, including application of weight, summation, application of bias, and application of an activation function.

During training of the network, weights and bias are subject to adjustment. Bias represents deviation of a prediction from an intended value. Weights represent strength of a connection between neurons. Each neuron in a network transforms data using a series of computations: a neuron multiplies an initial value by some weight, sums results with other values coming into the same neuron, adjusts the resulting number by the neuron's bias, and then normalizes the output with an activation function. The bias is a neuron-specific number that adjusts the neuron's value once all the connections are processed, and the activation function ensures values that are passed on lie within a tunable, expected range. This process is repeated until the final output layer can provide scores or predictions related to the classification task.

A function with a plurality of local minima is introduced to the activation function. The added element(s) of the introduced function provide a defense mechanism to the artificial network, thereby functioning as a security mechanism against an adversarial attack.

Adversarial examples are input to the neural networks created with the purpose of confusing the neural network and resulting in misclassification of input data. Such inputs may not be distinguishable to a human but serve to cause the neural network failure with identification of content, with the content including, but not limited to, image recognition, speech, and computer vision applications. In an embodiment, the attacker to the neural network adds distortions to an image to attempt an improper classification of the image by the network. To successfully attack the neural network, the attacker needs a useful gradient. By introducing a function to the activation function with the introduced function having at least one local minima, and in an embodiment at least one local maxima, the shape of the introduced function prevents the attacker from finding or obtaining the useful gradient. In an embodiment, the introduced function may be a trigonometric function, such as a sine wave having local minima and local maxima. Accordingly, the shape of the introduced function with one or more local minima, and in an embodiment one or more local maxima, confuses the attacker, thereby mitigating or preventing a successful attack of the neural network.

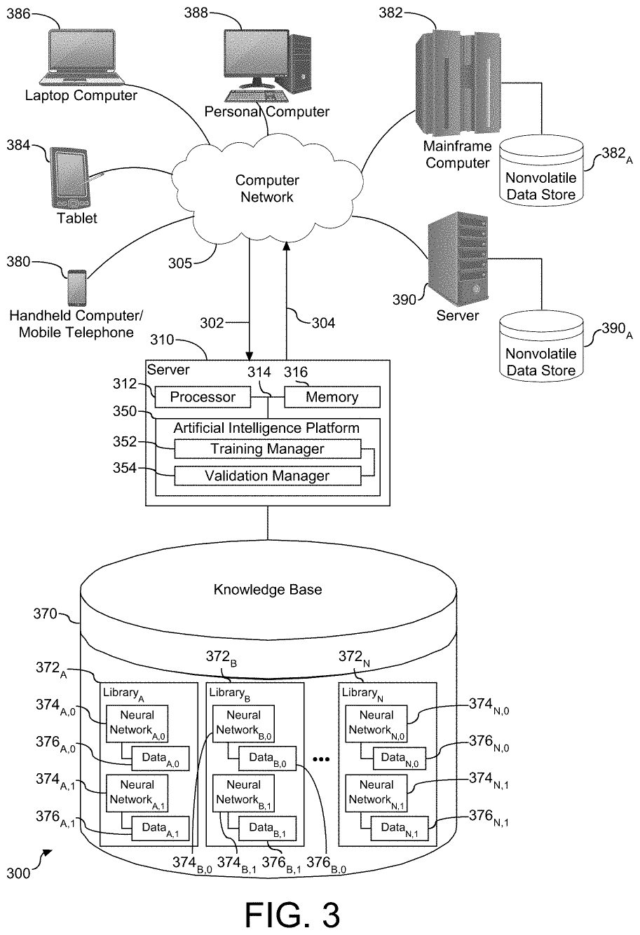

Referring to FIG. 3, a schematic diagram of an artificial intelligence (AI) platform and corresponding system (300) is depicted. As shown, a server (310) is provided in communication with a plurality of computing devices (380), (382), (384), (386), (388), and (390) across a network connection, e.g. computer network, (305). The server (310) is configured with a processing unit, e.g., a processor, in communication with memory across a bus. The server (310) is shown with an AI platform (350) operatively coupled to a knowledge base (370).

The AI platform (350) is operatively coupled to the network (305) to support neural network training from one or more of the computing devices (380), (382), (384), (386), (388), and (390). More specifically, the computing devices (380), (382), (384), (386), and (388) communicate with each other and with other devices or components via one or more wired and/or wireless data communication links, where each communication link may comprise one or more of wires, routers, switches, transmitters, receivers, or the like. In this networked arrangement, the server (310) and the network connection (305) enable communication detection, recognition, and resolution. Other embodiments of the server (310) may be used with components, systems, sub-systems, and/or devices other than those that are depicted herein.

The AI platform (350) is shown herein operatively coupled to the knowledge base (370), which is configured with one or more libraries of neural networks and corresponding training data. In an embodiment, the neural network(s) and/or the training data may be communicated to the knowledge base (370) from various sources across the network (305). By way of example, the knowledge base is shown with a plurality of libraries, shown herein by way of example is library_{A} (372_{A}), library_{B} (372_{B}), . . . , library_{N} (372_{N}). Each library is populated with one or more neural networks and operatively coupled training data. As shown herein, library_{A} (372_{A}) is shown with neural networks (374_{A,0}) and (374_{A,1}), and operatively coupled training data (376_{A,0}) and (376_{A,1}), respectively, library_{B} (372_{B}) is shown with neural networks (374_{B,0}) and (374_{B,1}), and operatively coupled training data (376_{B,0}) and (376_{B,1}), respectively, and library_{N} (372_{N}) is shown with neural networks (374_{N,0}) and (374_{N,1}), and operatively coupled training data (376_{N,0}) and (376_{N,1}), respectively. In an exemplary embodiment, each library may be directed to a specific subject matter. For example, in an embodiment, library_{A} (372_{A}) may be populated with items such as one or more artificial neural networks and corresponding training data directed to athletics, library_{B} (372_{B}) may be populated with items such as one or more artificial neural networks and corresponding training data directed at finance, etc. Similarly, in an embodiment, the libraries may be populated based on industry. Accordingly, the artificial intelligence platform (350) is operatively coupled to the knowledge domain (370) and the corresponding libraries.

The various computing devices (380), (382), (384), (386), (388), and (390) in communication with the network (305) may include access points to the artificial intelligence platform (350). The network (305) may include local network connections and remote connections in various embodiments, such that the AI platform (350) may operate in environments of any size, including local and global, e.g., the Internet. Additionally, the AI platform (350) serves as a back-end system that can make available a variety of knowledge extracted from or represented in documents, network accessible sources and/or structured data sources. In this manner, some processes populate the AI platform (350), with the AI platform (350) also including input interfaces to receive requests and respond accordingly.

As shown, content may be represented in one or more models operatively coupled to the AI platform (350) via the knowledge base (370). Content users may access the AI platform (350) and the operatively knowledge base (370) via a network connection or an Internet connection to the network (305), and may submit natural language, image data, voice data, etc., as input from which the AI platform (350) and associated tools may effectively determine an output response related to the input by leveraging the operatively coupled knowledge base (370) and a corresponding artificial neural network.

The AI platform (350) is shown herein with several tools, also referred to herein as program modules, to support neural network training, with the tools directed at improving performance and security of the corresponding artificial neural network(s). The tools include a training manager (352) and a validation manager (354). The training manager (352) leverages or receives training data populated in the knowledge base (370) or communicated across the network (305), and subjects a corresponding artificial neural network to training with the leveraged or received training data. As shown and described in FIGS. 1 and 2, the artificial neural network is structured with neurons organized into a plurality of layers, including an input layer, one or more hidden layers, and an output layer. The training manager (352) applies an activation function to a result of a biased sum of inputs and corresponding weights from a prior adjacent layer of the artificial neural network. More specifically, the training manager (352) introduces a training function configured with a plurality of local minima to the activation function. In an exemplary embodiment, the training function is a trigonometric function, such as a sine wave, with a plurality of local maxima in addition to the plurality of minima. In an embodiment, the training manager (352) embeds the training function in one or more hidden layers, e.g. (220) and (230), or the output layer, e.g. (240), of the artificial neural network. Mathematically, the maxima and minima of a function are referred to collectively as extrema, and represent the largest and smallest value of a function either within a given range or on the entire domain. Accordingly, high frequency and low amplitude elements are added to the artificial neural network to provide a defense mechanism to the artificial network, and functioning as a security mechanism against an adversarial attack.

The validation manager (354) is shown herein operatively coupled to the training manager (352). The validation manager (354) functions as a tool to validate or otherwise authenticate that one or more of the data points of the training data are within the bounds defined by the activation function, and in an exemplary embodiment, within the bounds defined by the local minima and/or the local maxima. The validation or authentication of the training data mitigates or in an embodiment eliminates an adversarial attached on the trained artificial neural network. In an exemplary embodiment, an adversarial attack on the artificial neural network needs a useful gradient to find local minima and the introduction of the training function with a plurality of local minima prevents or otherwise mitigates the adversarial attack. More specifically, the introduction of the plurality of local minima mitigates or prevents the adversarial attack from finding the useful gradient because a value of a corresponding loss function cannot be reduced due to the shape of the training function.

In an exemplary embodiment, the artificial neural network is trained to process images, wherein input to the network is in the form of pixels and associated pixel value. The pixel is a basic logical unit of a digital image or digital graphics. Multiple pixels can be arranged to form a complete image, video, text, or any visible element represented on a digital display device. In an exemplary embodiment, the training manager (352) applies the training function to each pixel value of the received training data. Similarly, in an embodiment, the training manager (352) applies the training function to a selection or subset of pixel values of the received training data.

Once trained, the artificial neural network receives and interprets input. For example, in an embodiment, the input may be directed at an image and corresponding image data, and the artificial neural network generates outputs classifying the input. More specifically, the artificial neural network applies the activation function and the validated training data to the received input, with the classified output being an interpretation of the input. The interpretation is expressed as output data which identifies the neural network's interpretation of the input.

The interpretation of the received input may be processed by the IBM Watson® server (310), and the corresponding artificial intelligence platform (350). The training manager (352) subjects one or more artificial neural networks to instruction using a variety of reasoning algorithms together with the introduced training function. There may be hundreds or even thousands of reasoning algorithms applied, each of which performs different analysis, e.g., comparisons. The validation manager (354) functions to validate data points within the training data to ensure or authenticate that the data points are within the bounds defined by the activation function. In some illustrative embodiments, the server (310) may be the IBM Watson® system available from International Business Machines Corporation of Armonk, N.Y., augmented with the mechanisms of the illustrative embodiments described hereafter.

The training manager (352) and the validation manager (354), hereinafter referred to collectively as AI tools, are shown as being embodied in or integrated within the artificial intelligence platform (350) of the server (310). The AI tools may be implemented in a separate computing system (e.g., 390) that is connected across the network (305) to the server (310). Wherever embodied, the AI tools function to train an artificial neural network with a training function applied to the activation function to mitigate an adversarial attack on the artificial neural network and thereby improve interpretation of input to the trained neural network.

Types of information handling systems that can utilize the artificial intelligence platform (350) range from small handheld devices, such as handheld computer/mobile telephone (380) to large mainframe systems, such as mainframe computer (382). Examples of handheld computer (380) include personal digital assistants (PDAs), personal entertainment devices, such as MP4 players, portable televisions, and compact disc players. Other examples of information handling systems include pen, or tablet computer (384), laptop, or notebook computer (386), personal computer system (388), and server (390). As shown, the various information handling systems can be networked together using computer network (305). Types of computer network (305) that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., server (390) utilizes nonvolatile data store (390_{A}), and mainframe computer (382) utilizes nonvolatile data store (382_{A}). The nonvolatile data store (382_{A}) can be a component that is external to the various information handling systems or can be internal to one of the information handling systems.

An information handling system employed to support the artificial intelligence platform (350) may take many forms, some of which are shown in FIG. 3. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

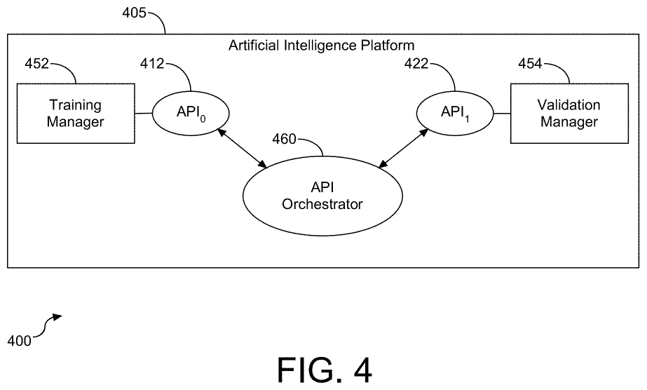

An Application Program Interface (API) is understood in the art as a software intermediary between two or more applications. With respect to the artificial intelligence platform (350) shown and described in FIG. 3, one or more APIs may be utilized to support one or more of the tools (352) and (354) and their associated functionality. Referring to FIG. 4, a block diagram (400) is provided illustrating the tools (352) and (354) and their associated APIs. As shown, a plurality of tools are embedded within the AI platform (405), with the tools including the training manager (452) associated with API₀ (412), and the validation manager (454) associated with API₁ (422). Each of the APIs may be implemented in one or more languages and interface specifications. API₀ (412) provides functional support to train an artificial neural network with training data, with the training including introduction of a training function to the activation function; and API₁ (422) provides functional support to validate one or more data points of the training data to ensure that these data points are within the bounds defined by the activation function. As shown, each of the APIs (412) and (422) are operatively coupled to an API orchestrator (460), otherwise known as an orchestration layer, which is understood in the art to function as an abstraction layer to transparently thread together the separate APIs. In an embodiment, the functionality of the separate APIs may be joined or combined. As such, the configuration of the APIs shown herein should not be considered limiting. Accordingly, as shown herein, the functionality of the tools may be embodied or supported by their respective APIs.

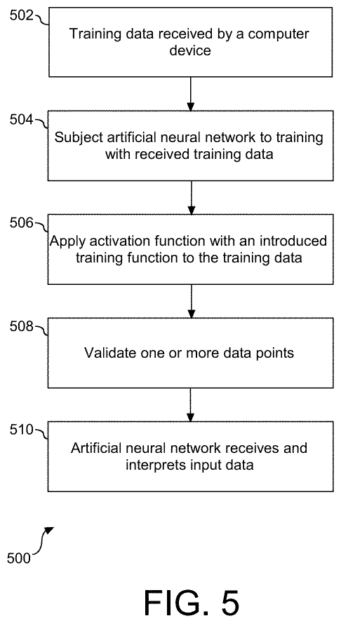

Referring to FIG. 5, a flow chart (500) is provided to illustrate a process for training an artificial neural network (ANN) with validation of data points of a corresponding training set. As shown, training data is received by a computer device (502). The training data includes one or more data points and corresponding output data. The goal of training the ANN is when completed the ANN can receive input data and generate output data classifying the received input data. For example, with respect to image recognition and classification, the ANN may receive an image as input data, convert the image to a set of pixels, process the set of pixels and corresponding pixel values through the ANN, and generate output data corresponding to the image, with the generated output classifying an interpretation of the received image. The ANN is not limited to image recognition. In an embodiment, the ANN may be training to recognize other mediums of expression, such as audio, and as such the scope of the ANN should not be considered limiting.

The ANN is subject to training with the received training data (504). As known in the art and shown in FIGS. 1 and 2, the ANN is configured with a plurality of layers, including an input layer, one or more internal layers, also referred to herein as hidden layers, and an output layer. The training data is subject to validation (506). It is understood in the art that neural models trained on data from untrustworthy sources provide adversaries within an opportunity to manipulate or tamper with the model by inserting invalid date into the training set. As used herein, an adversary is at least one entity within intent to corrupt a neural model through alteration of model behavior by manipulating data that is used to train the model, i.e., the training data set, thereby affecting a source-target misclassification attack. An adversary may choose a particular mechanism for the intended victim of the planned attack based on having access to the training data. More specifically, the adversary may affect an attack on a neural model through gaining access to the training data set that will be used to train the model, thereby corrupting the model in a manner that may be undetected.

The validation of the training data step (506) includes application of the activation function to a result of a biased sum of inputs and corresponding weights from a prior adjacent layer of the ANN, and introduction of a function to the activation function. The training function is embedded in one or more hidden layers of the ANN, and in an embodiment the introduced function is embedded in the output layer of the ANN. The introduced function at step (506) has at least one local minima, and in an embodiment at least one local maxima. The shape of the introduced function prevents the attacker from finding or obtaining the useful gradient. In an exemplary embodiment, the introduced function may be a trigonometric function, such as a sine wave having local minima and local maxima. By introducing the function in one or more of the internal layers of the ANN, noise is added to the ANN. In an embodiment and with respect to an ANN trained for image recognition, the function is applied and introduced to each pixel value of the training data. The local values, e.g. local minima and/or local maxima, serve to confuse an attacker to the ANN. The introduction of the function prevents the attack from finding a useful gradient because a value of a loss function cannot be reduced due to the shape of the introduced function. Following step (506) and introduction of the function, the one or more data points are subject to validation (508) to ensure that the data points of the training data are within the bounds defined by the activation with the introduced function. Accordingly, the training of the ANN includes introduction of the function and validation of training data within the bounds of the activation function as modified by the introduced function.

Once the ANN has been trained, the ANN may receive and interpret input data (510). More specifically, at step (510) the trained ANN applies the activation function and the validated training data to the received input data. Output data classifying the interpreted input data is generated from the ANN (512). In an exemplary embodiment, the ANN is configured to support and enable recognition in the mediums of image, speech, and computer vision applications, with the input data being a sample in one of the mediums, and the output data being an interpretation of the input data in the corresponding medium.

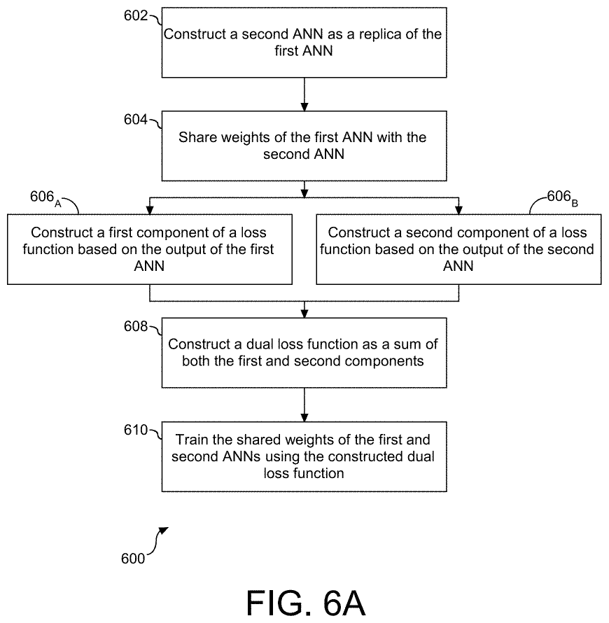

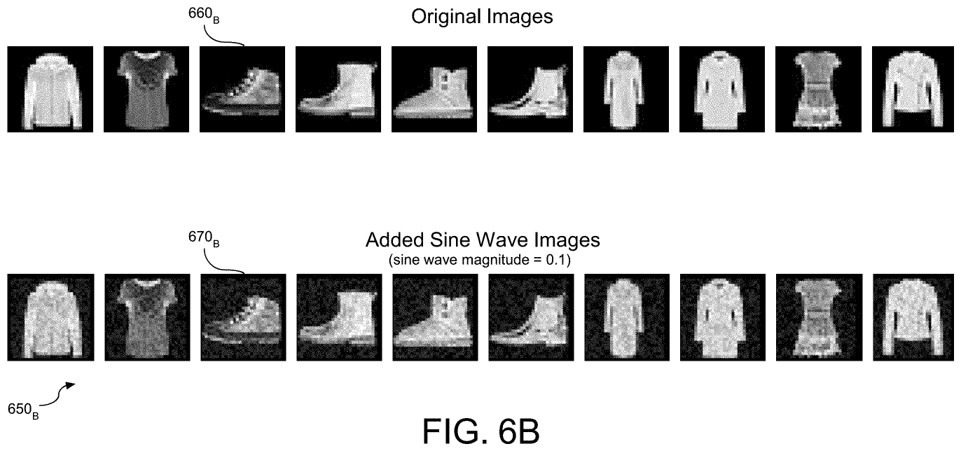

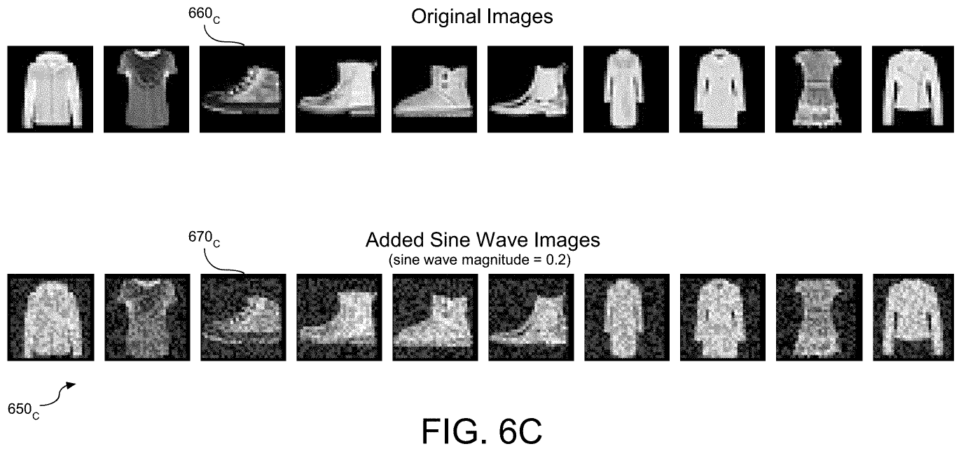

Referring to FIG. 6A, a flow chart (600) is provided to illustrate a process for creating a decoy ANN to further mitigate an adversarial attack on the ANN trained with the introduced function. As shown, a second ANN is constructed as a replica of a first ANN, with the introduced function of the first ANN either omitted or otherwise removed from the second ANN (602). The weights of the first ANN are shared with the second ANN (604), such as in a Siamese Network. Both the first ANN and the second ANN are subject to training, which in one embodiment is conducted in parallel. As shown, a first component of a loss function based on output of the first ANN is constructed (606A) in parallel with construction of a second component of a loss function based on the output of the second ANN (606B). The first component is only applied to the output of the first ANN, and the second component is only applied to the output of the second ANN. It is understood in the art that neural networks are trained using an optimization process that requires a loss function to calculate the model error. A dual loss function is constructed as a sum of both the constructed first and second components (608). The shared weights of the first and second ANNs are trained using the constructed dual loss function (610).

An example of visual images with the constructed first and second ANNs is described below. Referring to FIG. 6B, a block diagram (650B) is provided visualing what the first ANN does in the image recognition process. As shown, a plurality of original images (660B) is provided and subject to image recognition by the trained first ANN. In this example, the first ANN has a trigonometric function in the form of a sine wave having a magnitude of 0.1. As shown, the images (670B) are an internal representation of values in the first ANN and are partially obscured but recognizable. Referring to FIG. 6C, a block diagram (650C) is provided visualing what the first ANN does in the image recognition process. Similar to the example shown in FIG. 6A, a plurality of original images (660C) is provided and subject to image recognition by the trained first ANN. In this example, the first ANN has a trigonometric function in the form of a sine wave having a magnitude of 0.2. As shown, the images (670C) are an internal representation of values in the first ANN and are partially obscured but recognizable. The magnitude of the sine wave is increased in the example shown in FIG. 6C from the example shown in FIG. 6B, with the visual effects shown in the images (670B) and (670C). As shown, the first ANN can be trained with a sine wave having magnitudes of different values. When training with the dual loss function is complete, the second ANN, as shown and described in FIG. 6A without the sine wave, will usually not recognize the original images (660B) and (660C) shown in FIGS. 6B and 6C, respectively.

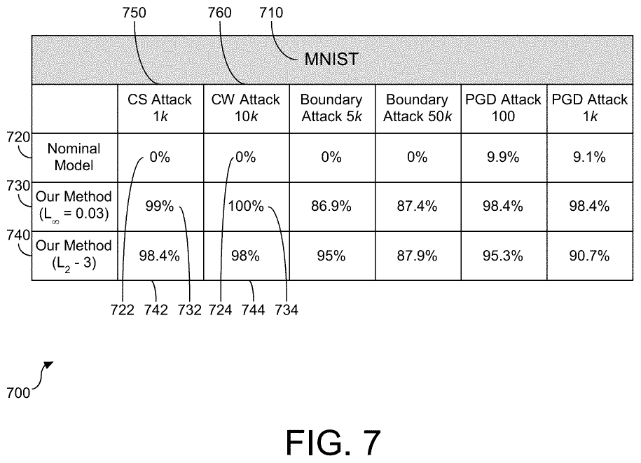

As shown and described in FIGS. 1-6C, a function, such as a sine wave, is introduced to the activation function to obfuscate gradients of the ANN. Referring to FIG. 7, a chart (700) is provided to illustrate an example of testing and evaluation of the ANN with the modified activation function. A data set, (710), was provided with test images and subject to classification by three different models, including a nominal model (720) without introduction of the (trigonometric) function, the ANN with the introduced function and a first corresponding noise level (730), and the ANN with the introduced function and a second corresponding noise level (740). In the example shown herein, the second corresponding noise level is increased from the first corresponding noise level by a factor of ten. The numerical values entered in the chart (700) indicate an attack failure rate of the model when subject to attack. For example, a Carlini & Wagner (CW) attack is shown with 1,000 test images (750), with corresponding attack failure rates of the models shown at (722), (732), and (742). Similarly, the CW attack is shown with 10,000 iterations (760), with corresponding attack failure rates of the models shown at (724), (734), and (744). Three different classes of attacks are shown with each attack class demonstrated with two different quantities of iterations. As demonstrated, the ANN with the greatest attack failure rates are models with the activation function modified with the introduced function as shown and described in FIGS. 3-5.

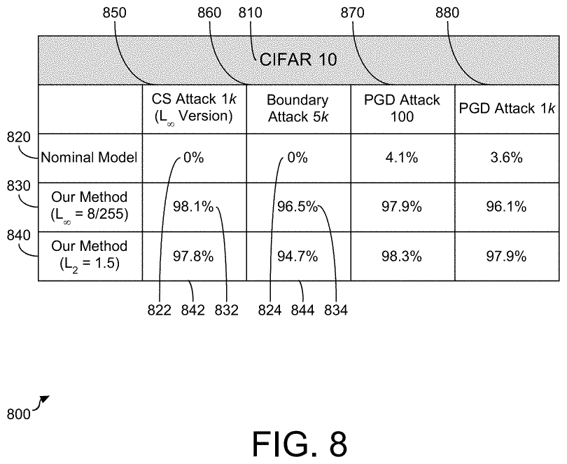

Referring to FIG. 8, a chart (800) is provided to illustrate an example of testing and evaluation of the ANN with the modified activation function. A data set, (810), was provided with test images and subject to classification by three different models, including a nominal model (820) without introduction of the (trigonometric) function, the ANN with the introduced function and a first corresponding noise level (830), and the ANN with the introduced function and a second corresponding noise level (840). In the example shown herein, the second corresponding noise level is increased from the first corresponding noise level. The numerical values entered in the chart (800) indicate the attack failure rate of the model when subject to attack. For example, a (CW) attack is shown with 1,000 test images (850), with corresponding attack failure rates of the models shown at (822), (832), and (842). Similarly, a boundary attack is shown with test images (860), with corresponding attack failure rates of the models shown at (824), (834), and (844). In an embodiment, five thousand iterations of the boundary attack are run with one thousand test images. Different attacks are shown with the same quantity of test images, and at (870) and (880), the same form of attack is shown with different quantities of iterations. As demonstrated, the ANN with the greatest attack failure rates are models with the activation function modified with the introduced function as shown and described in FIGS. 3-5.

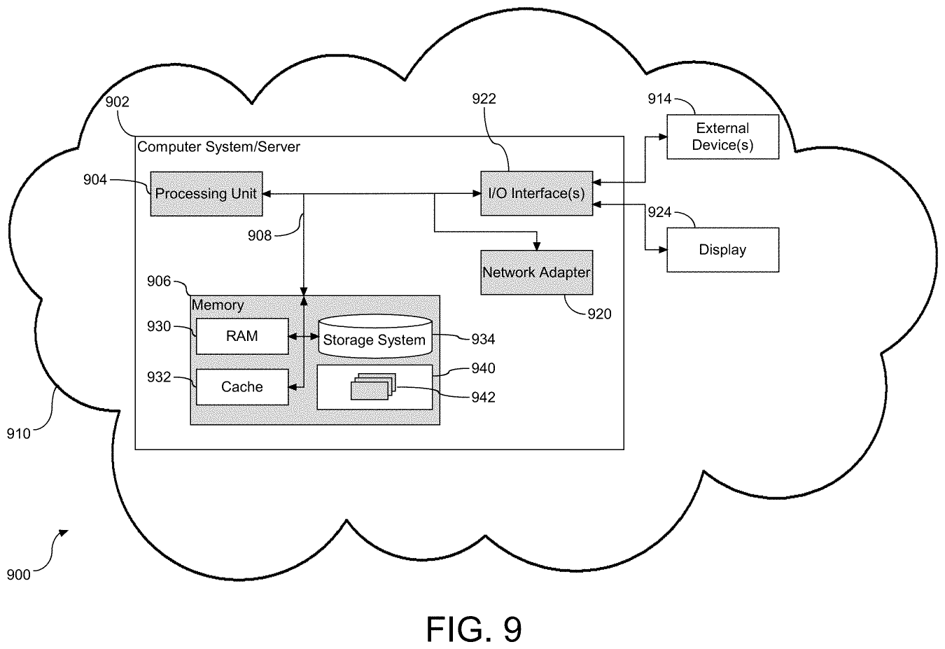

As shown and described in FIGS. 1-5, a computer system, program product, and method are provided to support security of an artificial neural network through obfuscation. Embodiments shown and described herein may be in the form of a computer system, a computer program product, and a computer implemented method. Aspects of the tools (352) and (354) and their associated functionality may be embodied in a computer system/server in a single location, or in an embodiment, may be configured in a cloud based system sharing computing resources. With reference to FIG. 9, a block diagram (900) is provided illustrating an example of a computer system/server (902), hereinafter referred to as a host (902) in communication with a cloud based support system (910), to implement the system, tools, and processes described above in FIGS. 1-8. In an embodiment, host (902) is a node of a cloud computing environment. The host (902) is operational with numerous other general purpose or special purpose computing system environments or configurations. Examples of well-known computing systems, environments, and/or configurations that may be suitable for use with host (902) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

The host (902) may be described in the general context of computer system-executable instructions, such as program modules, being executed by a computer system. Generally, program modules may include routines, programs, objects, components, logic, data structures, and so on that perform particular tasks or implement particular abstract data types. The host (902) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, the host (902) is shown in the form of a general-purpose computing device. The components of host (902) may include, but are not limited to, one or more processors or processing units (904), e.g. hardware processors, a system memory (906), and a bus (908) that couples various system components including system memory (906) to processor (904). The bus (908) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. The host (902) typically includes a variety of computer system readable media. Such media may be any available media that is accessible by the host (902) and it includes both volatile and non-volatile media, removable and non-removable media.

The system memory (906) can include computer system readable media in the form of volatile memory, such as random access memory (RAM) (930) and/or cache memory (932). By way of example only, storage system (934) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus (908) by one or more data media interfaces.

Program/utility (940), having a set (at least one) of program modules (942), may be stored in the system memory (906) by way of example, and not limitation, as well as an operating system, one or more application programs, other program modules, and program data. Each of the operating systems, one or more application programs, other program modules, and program data or some combination thereof, may include an implementation of a networking environment. Program modules (942) generally carry out the functions and/or methodologies of embodiments to dynamically interpret and understanding request and action descriptions, and effectively augment corresponding domain knowledge. For example, the set of program modules (942) may include the tools (352) and (354) as shown in FIG. 3.

The host (902) may also communicate with one or more external devices (914), such as a keyboard, a pointing device, etc.; a display (924); one or more devices that enable a user to interact with the host (902); and/or any devices (e.g., network card, modem, etc.) that enable the host (902) to communicate with one or more other computing devices. Such communication can occur via Input/Output (I/O) interface(s) (922). Still yet, the host (902) can communicate with one or more networks such as a local area network (LAN), a general wide area network (WAN), and/or a public network (e.g., the Internet) via network adapter (920). As depicted, the network adapter (920) communicates with the other components of the host (902) via the bus (908). In an embodiment, a plurality of nodes of a distributed file system (not shown) is in communication with the host (902) via the I/O interface (922) or via the network adapter (920). It should be understood that although not shown, other hardware and/or software components could be used in conjunction with the host (902). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (906), including RAM (930), cache (932), and storage system (934), such as a removable storage drive and a hard disk installed in a hard disk drive.

Computer programs (also called computer control logic) are stored in memory (906). Computer programs may also be received via a communication interface, such as network adapter (920). Such computer programs, when run, enable the computer system to perform the features of the present embodiments as discussed herein. In particular, the computer programs, when run, enable the processing unit (904) to perform the features of the computer system. Accordingly, such computer programs represent controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

The functional tools described in this specification have been labeled as managers. A manager may be implemented in programmable hardware devices such as field programmable gate arrays, programmable array logic, programmable logic devices, or the like. The managers may also be implemented in software for processing by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the managers and achieve the stated purpose of the managers.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

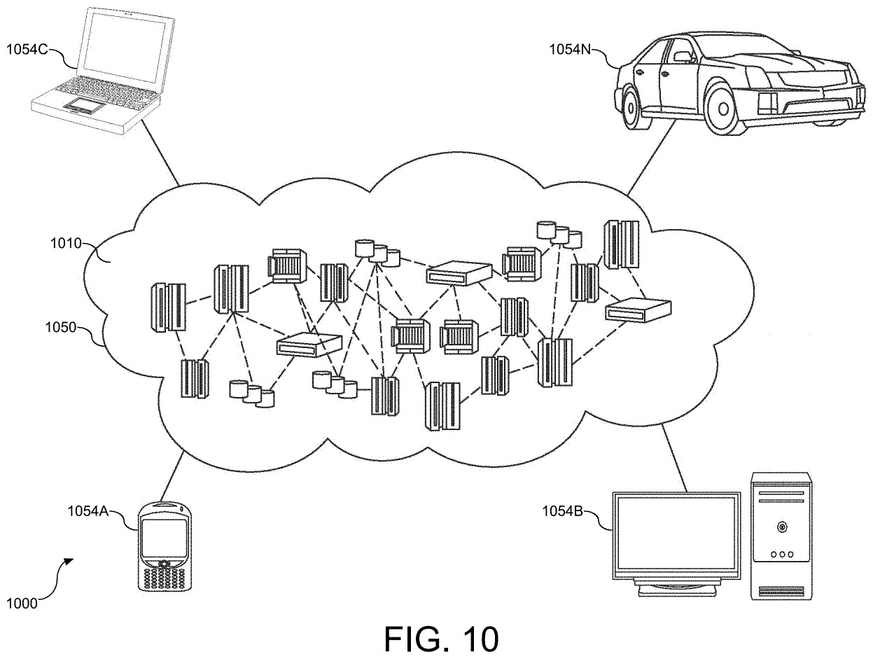

Referring now to FIG. 10, an illustrative cloud computing network (1000) is shown and described. As shown, cloud computing network (1000) includes a cloud computing environment (1050) having one or more cloud computing nodes (1010) with which local computing devices used by cloud consumers may communicate. Examples of these local computing devices include, but are not limited to, personal digital assistant (PDA) or cellular telephone (1054A), desktop computer (1054B), laptop computer (1054C), and/or automobile computer system (1054N). Individual nodes within nodes (1010) may further communicate with one another. They may be grouped (not shown) physically or virtually, in one or more networks, such as Private, Community, Public, or Hybrid clouds as described hereinabove, or a combination thereof. This allows cloud computing environment (1000) to offer infrastructure, platforms and/or software as services for which a cloud consumer does not need to maintain resources on a local computing device. It is understood that the types of computing devices (1054A-N) shown in FIG. 10 are intended to be illustrative only and that the cloud computing environment (1050) can communicate with any type of computerized device over any type of network and/or network addressable connection (e.g., using a web browser).

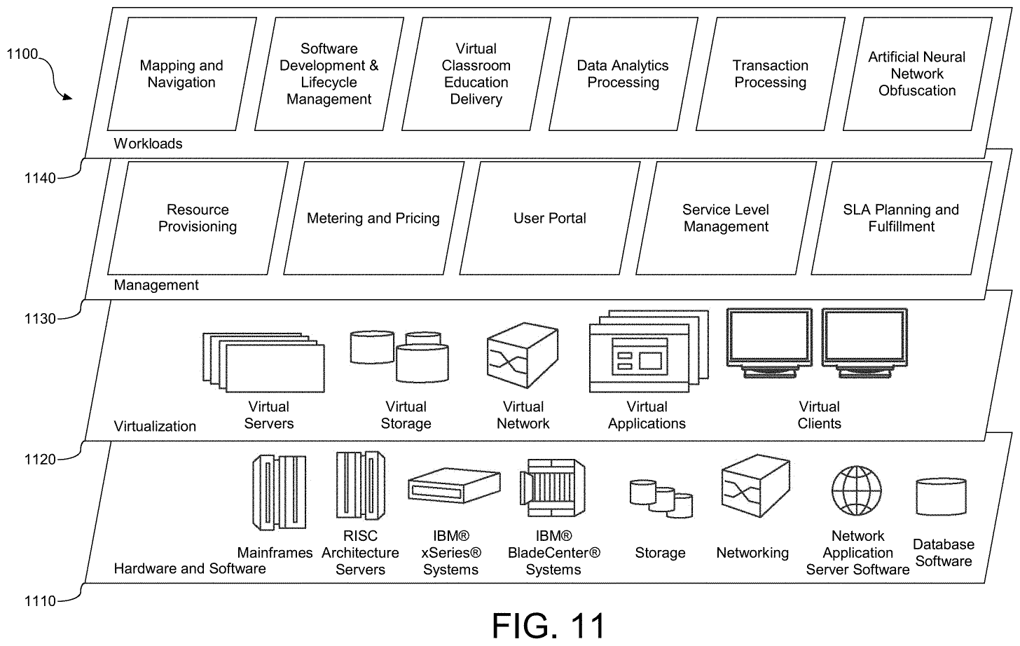

Referring now to FIG. 11, a set of functional abstraction layers (1000) provided by the cloud computing network of FIG. 10 is shown. It should be understood in advance that the components, layers, and functions shown in FIG. 11 are intended to be illustrative only, and the embodiments are not limited thereto. As depicted, the following layers and corresponding functions are provided: hardware and software layer (1110), virtualization layer (1120), management layer (1130), and workload layer (1140).

The hardware and software layer (1110) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (1120) provides an abstraction layer from which the following examples of virtual entities may be provided: virtual servers; virtual storage; virtual networks, including virtual private networks; virtual applications and operating systems; and virtual clients.

In an example, management layer (1130) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (1140) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and artificial neural network obfuscation.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles. As used herein, the term “and/or” means either or both (or one or any combination or all of the terms or expressed referred to).

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, a method, and/or a computer program product is operative to support artificial neural network obfuscation to mitigate attacks thereon while maintaining and enabling network integrity and processing.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. Accordingly, the scope of protection of the embodiments is limited only by the following claims and their equivalents.

What is claimed is:

1. A computer system comprising:
a processing unit operatively coupled to memory, the processing unit configured to implement at least one program module to:
introduce a function having as input results from one or more previous layers of a first artificial neural network (ANN), the introduced function having at least one local minima;
the first ANN to receive input data, including the first ANN to apply the introduced function to the received input; and
the trained ANN to generate output data classifying interpreted received input.

2. The computer system of claim 1, wherein the introduced function is a trigonometric function.

3. The computer system of claim 2, wherein the trigonometric function is a sine wave.

4. The computer system of claim 1, further comprising the at least one program model to construct a decoy to an adversarial attack, including:
construct a second ANN as a replica of the first ANN, and omit the introduced function of the first ANN from the second ANN;
the first ANN sharing its weights with the second ANN; and
perform a training process with a training data set for modifying the shared weights of the first and second ANNs, the training process to create a trained first ANN and a trained second ANN, the trained first ANN commonly producing a correct answer on the training set and the second ANN commonly producing an incorrect answer on the training set.

5. The computer system of claim 4, wherein the constructed decoy mitigates an adversarial attack on the trained first ANN.

6. The computer system of claim 1, wherein the introduced function is embedded in the one or more hidden layers or the output layer of the ANN.

7. A computer program product to support neural network security, the computer program product comprising a computer readable storage medium having program code embodied therewith, the program code executable by a processor to:
introduce a function having as input results from one or more previous layers of a first artificial neural network (ANN), the introduced function having at least one local minima;
the first ANN to receive input data, including the first ANN to apply the introduced function to the received input; and
the first ANN to generate output data classifying interpreted received input.

8. The computer program product of claim 7, wherein the introduced function is a trigonometric function.

9. The computer program product of claim 8, wherein the trigonometric function is a sine wave.

10. The computer program product of claim 7, further comprising program code to construct a decoy to an adversarial attack, including:
construct a second ANN as a replica of the first ANN, and omit the introduced function of the first ANN from the second ANN;
the first ANN sharing its weights with the second ANN; and
perform a training process with a training data set for modifying the shared weights of the first and second ANNs, the training process to create a trained first ANN and a trained second ANN, the trained first ANN commonly producing a correct answer on the training set and the second ANN commonly producing an incorrect answer on the training set.

11. The computer program product of claim 10, wherein the constructed decoy mitigates an adversarial attack on the trained first ANN.

12. The computer program product of claim 7, further comprising program code to embed the introduced function in the one or more hidden layers or the output layer of the ANN.

13. A method comprising:
introducing a function having as input results from one or more previous layers of a first artificial neural network (ANN), the introduced function having at least one local minima;
the first ANN receiving input data, including the first ANN applying the introduced function to the received input; and
generating output data classifying interpreted received input.

14. The method of claim 13, wherein the introduced function is a trigonometric function.

15. The method of claim 14, wherein the trigonometric function is a sine wave.

16. The method of claim 13, further comprising constructing a decoy to an adversarial attack, including:
constructing a second ANN as a replica of the first ANN, and omitting the introduced function of the first ANN from the second ANN;
the first ANN sharing its weights with the second ANN; and
performing a training process with a training data set for modifying the shared weights of the first and second ANNs, the training process resulting in a trained first ANN and a trained second ANN, the trained first ANN commonly producing a correct result on the training set and the second ANN commonly producing an incorrect answer on the training set.

17. The method of claim 16, wherein the constructed decoy mitigates an adversarial attack on the trained first ANN.

18. The method of claim 13, wherein the introduced function is embedded in the one or more hidden layers or the output layer of the ANN.
